(19) United States
(12) Patent Application Publication
(10) Pub. No.: US 2026/0253368 A1
(43) Pub. Date: Aug. 27, 2026

(54) SYSTEMS AND METHODS FOR IMAGE NORMALIZATION

(71) Applicant: Centurylink Intellectual Property LLC, Denver, CO (US)

(72) Inventors: Dean Ballew, Sterling, VA (US); John R.B. Woodworth, Amissville, VA (US)

(73) Assignee: Centurylink Intellectual Property LLC, Denver, CO (US)

(21) Appl. No.: 19/444,736

(22) Filed: Jan. 9, 2026

Related U.S. Application Data
(60) Provisional application No. 63/764,054, filed on Feb. 27, 2025.

(51) Int. Cl. G06V 10/32; G06T 5/60; G06T 5/80; G06T 5/90; G06T 7/00; G06T 7/80; G06V 10/24; G06V 10/75

(52) U.S. Cl. CPC G06V 10/32; G06T 5/60; G06T 5/80; G06T 5/90; G06T 7/0004; G06T 7/0012; G06T 7/80; G06V 10/242; G06V 10/7515; G06T 2207/30148; G06T 2207/30196

(57) ABSTRACT

Novel tools and techniques are provided for implementing image normalization. In examples, a computing system may may determine whether an image of an object, which has been received, has associated calibration metadata that is accessible. If so, the computing system may access and extract, from the calibration metadata, calibration data associated with an orientation of the object relative to an image capture device, and may determine an amount by which the orientation of the object within the image should be changed to match an orientation of a reference object within a normalized reference image, based on the calibration data. The computing system may perform image processing on the image to produce a normalized image, by causing the orientation of the object within the image to change by the amount. The computing system may send the normalized image to a post processing system.

### CROSS-REFERENCE TO RELATED APPLICATIONS

This application claims the benefit of U.S. Provisional Application No. 63/764,054 filed Feb. 27, 2025, entitled “Systems and Methods for Image Normalization,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing image normalization.

### BACKGROUND

Artificial intelligence (“AI”)/machine learning (“ML”) analysis on images can provide insights into a wide number of objects and fields. In the case of medical images, for instance, AI/ML analysis can lead to life-saving medical breakthroughs and diagnostics. Unfortunately, cameras and conditions such as camera angles, lighting, lens distortions, etc., can vary dramatically leading to issues with portability, functional capability, and accuracy. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing image normalization, in accordance with various embodiments.

FIGS. 2A and 2B depict an example sequence flow for implementing image normalization, in accordance with various embodiments.

FIGS. 3A-3E depict flow diagrams illustrating an example method for implementing image normalization, in accordance with various embodiments.

FIGS. 4A-4E depict flow diagrams illustrating another example method for implementing image normalization, in accordance with various embodiments.

FIG. 5 depicts flow diagrams illustrating yet another method for implementing image normalization, in accordance with various embodiments.

FIG. 6 depicts a block diagram illustrating an exemplary computer or system hardware architecture, in accordance with various embodiments.

### DETAILED DESCRIPTION OF CERTAIN EMBODIMENTS

### Overview

As briefly discussed above, cameras and conditions such as camera angles, lighting, lens distortions, etc., can vary dramatically leading to issues with portability, functional capability, and accuracy. That is, with varying camera angles, lighting, etc., images of objects can vary, making analysis of aspects of images or the objects captured therein difficult across multiple similar objects. This compounds issues with analysis (e.g., AI/ML analysis) of such images to diagnose conditions, determine characteristics of objects, etc.

The present technology provides for image normalization that enables a standard environment and image processing techniques to adjust, compensate, and normalize images and image structures upon which image processing can take place. In this manner, with normalized images of objects, AI/ML image processing can produce more consistent and accurate analyses and/or diagnoses of conditions and/or characteristics of objects (e.g., at least a portion of a body of a human, at least a portion of a body of an animal, at least a portion of a plant, at least a portion of a telecommunications component, at least a portion of a semiconductor device, at least a portion of a vehicle, or at least a portion of a manufactured component, etc.).

In examples, a computing system may receive a first image of a first object, and may determine whether the first image of the first object has an associated set of calibration metadata that is accessible by the computing system. When it is determined either that there is no calibration metadata that is associated with the first image of the first object or that the first set of calibration metadata that is associated with the first image of the first object is not accessible, the computing system may send the first image of the first object to a first AI system, and may receive, from the first AI system, a first amount by which an orientation of the first object within the first image should be changed to match an orientation of a reference object within a normalized reference image. The computing system may perform AI-assisted image processing on the first image to produce an AI-assisted normalized first image, the AI-assisted image processing including causing the orientation of the first object within the first image to change by the first amount to match the orientation of the reference object within the normalized reference image. The computing system may send the AI-assisted normalized first image to a post processing system.

When it is determined that a first set of calibration metadata that is associated with the first image of the first object is accessible, the computing system may access the first set of calibration metadata, may extract, from the first set of calibration metadata, first calibration data associated with an orientation of the first object relative to an image capture device at a time that the first image was captured by the image capture device, and may determine a second amount by which the orientation of the first object within the first image should be changed to match the orientation of the reference object within the normalized reference image, based on the first calibration data. The computing system may perform image processing on the first image to produce a normalized first image, the image processing including causing the orientation of the first object within the first image to change by the second amount to match the orientation of the reference object within the normalized reference image. The computing system may send the normalized first image to the post processing system.

These and other aspects of the image normalization system and process are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including: receiving, by a computing system, a first image of a first object; determining, by the computing system, whether the first image of the first object has an associated set of calibration metadata that is accessible by the computing system; when it is determined that a first set of calibration metadata that is associated with the first image of the first object is accessible, accessing, by the computing system, the first set of calibration metadata; extracting, by the computing system and from the first set of calibration metadata, first calibration data associated with an orientation of the first object relative to an image capture device at a time that the first image was captured by the image capture device; determining, by the computing system, a first amount by which the orientation of the first object within the first image should be changed to match an orientation of a reference object within a normalized reference image, based on the first calibration data; performing, by the computing system, image processing on the first image to produce a normalized first image, the image processing including causing the orientation of the first object within the first image to change by the first amount to match the orientation of the reference object within the normalized reference image; and sending, by the computing system, the normalized first image to a post processing system; and when it is determined either that there is no calibration metadata that is associated with the first image of the first object or that the first set of calibration metadata that is associated with the first image of the first object is not accessible, sending, by the computing system, the first image of the first object to a first AI system; receiving, by the computing system and from the first AI system, a second amount by which the orientation of the first object within the first image should be changed to match the orientation of the reference object within the normalized reference image; performing, by the computing system, AI-assisted image processing on the first image to produce an AI-assisted normalized first image, the AI-assisted image processing including causing the orientation of the first object within the first image to change by the second amount to match the orientation of the reference object within the normalized reference image; and sending, by the computing system, the AI-assisted normalized first image to the post processing system.

In another aspect, the technology relates to a system, including a processing system and memory coupled to the processing system. The memory includes computer executable instructions that, when executed by the processing system, causes the system to perform operations including: receiving a first image of a first object; sending the first image of the first object to a first AI system; receiving, from the first AI system, a first amount by which an orientation of the first object within the first image should be changed to match an orientation of a reference object within a normalized reference image; performing AI-assisted image processing on the first image to produce an AI-assisted normalized first image, the AI-assisted image processing including causing the orientation of the first object within the first image to change by the first amount to match the orientation of the reference object within the normalized reference image; and sending the AI-assisted normalized first image to a post processing system.

In yet another aspect, the technology relates to a method, including: receiving, by a computing system, a first image of a first object; accessing, by the computing system, a first set of calibration metadata that is associated with the first image of the first object; extracting, by the computing system and from the first set of calibration metadata, first calibration data associated with an orientation of the first object relative to an image capture device at a time that the first image was captured by the image capture device; determining, by the computing system, a first amount by which the orientation of the first object within the first image should be changed to match an orientation of a reference object within a normalized reference image, based on the first calibration data; performing, by the computing system, image processing on the first image to produce a normalized first image, the image processing including causing the orientation of the first object within the first image to change by the first amount to match the orientation of the reference object within the normalized reference image; and sending, by the computing system, the normalized first image to a post processing system.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

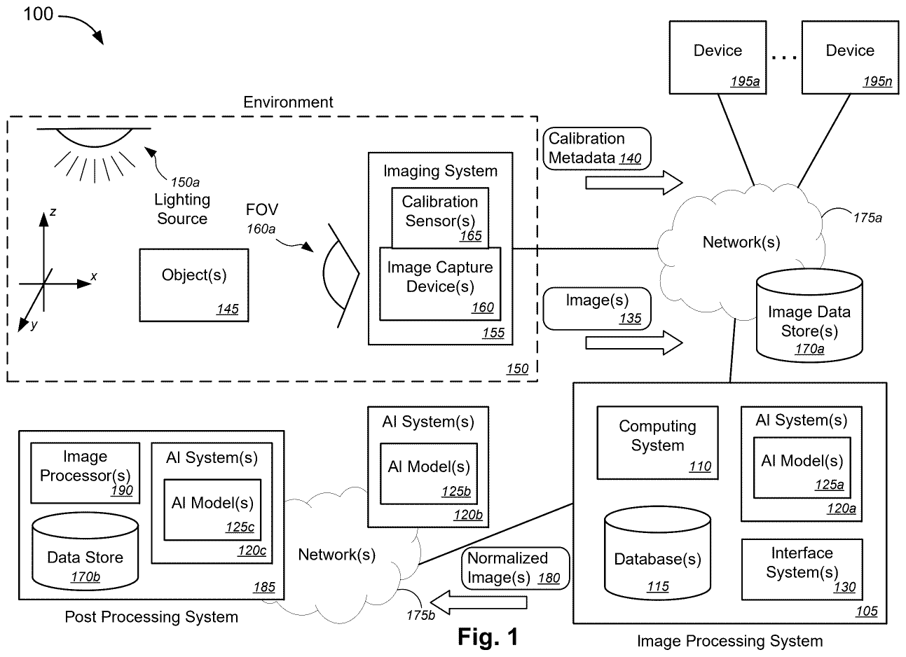

Turning to the embodiments as illustrated by the drawings, FIG. 1-5 illustrate some of the features of methods, systems, and apparatuses for implementing image normalization, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing image normalization, in accordance with various embodiments.

In the non-limiting embodiment of FIG. 1, system 100 may include an image processing system 105, which may include a computing system 110 and a database(s) 115. In some examples, the image processing system 105 may further include an AI system(s) 120a that trains and uses AI model(s) 125a. In some cases, the image processing system 105 may further include an interface system(s) 130. In examples, image(s) 135 and calibration metadata 140 corresponding to object(s) 145 in environment 150 and calibration data for an imaging system 155 (which may include an image capture device(s) 160 and calibration sensor(s) 165), respectively, may be received by the image processing system 105 and/or stored in an image data store(s) 170a, via network(s) 175a. Within the environment 150, the image capture device(s) 160, having a field of view (“FOV”) 160a that covers at least a portion of the object(s) 145, may capture the image(s) 135 of the object(s) 145. Calibration sensor(s) 165, which may be mounted on or within the imaging system 155 and/or the image capture device(s) 160, may measure, monitor, or collect the calibration metadata 140, which may be associated with calibration of the imaging system 155 and/or the image capture device(s) 160, in some cases, relative to the object(s) 145, conditions within the environment 150, and/or a reference point/surface within the environment 150. In examples, the environment 150 may include an indoor space or an outdoor space, and, in some cases, may include a building (e.g., a medical facility, a laboratory, a data center, a central office, a factory, a residential building, a commercial building, a government building, a sporting arena or facility, a gaming facility, an equipment testing facility, a vehicle testing facility, or other structure), a roadway or parking structure, a nature space (e.g., a forest, a jungle, a waterbody, a meadow, a mountain, a desert, etc.), an agricultural space (e.g., a farm, an orchard, etc.), a manmade natural setting (e.g., a park, a preserve, a field, a zoo, etc.), and/or the like.

In some examples, the object(s) 145 may include one or more of at least a portion of a body of a human, at least a portion of a body of an animal (e.g., a mammal, a fish, an amphibian, a reptile, an avian, an insect, or other fauna), at least a portion of a plant (e.g., a tree, a flowering plant, a bush or shrub, grasses, or other flora), at least a portion of a telecommunications component (e.g., switches, routers, servers, firewalls, gateway devices, customer premises equipment (“CPE”), etc.), at least a portion of a semiconductor device (e.g., integrated circuits (“ICs”), transistors, diodes, etc.), at least a portion of a vehicle, or at least a portion of a manufactured component, or the like. In some instances, the imaging system 155 may include one of a camera, a medical scanning device, a quality control scanning system, or a diagnostic scanning system, or the like. In some cases, the image capture device(s) 160 may include one of a light-based image capture device (e.g., an optical camera or a camera operating in the visual spectrum, a camera operating in the infrared (“IR”) spectrum, or a camera operating in the ultraviolet (“UV”) spectrum, etc.), a laser-based image capture device (e.g., a light detection and ranging (“lidar”) imaging device, or the like), an X-ray-based imaging device (e.g., an X-ray radiography system, a computed tomography (“CT”) scanning system, a fluoroscopy-based imaging system, a mammography system, an angiography system, or the like), an ionizing radiation-based imaging device (e.g., imaging systems using alpha particles, beta particles, positrons, gamma rays, or X-rays, etc.), a magnetic field-based imaging device (e.g., a magnetic resonance imaging (“MRI”) system, or the like), a sound-based imaging device (e.g., an ultrasound imaging device, or the like), a radiation emission detection-based imaging device (e.g., positron emission tomography (“PET”) system, or the like), or the like.

In examples, the calibration metadata 140 either may be embedded within a corresponding image 135 or may be generated by a calibration system based on sensor data that are collected by the calibration sensor(s) 165 at the time that that image 135 was captured by the image capture device(s) 160. In some examples, calibration metadata 140 may include one or more of orientation data, distance or zoom level data, lighting condition data, color description data, contrast data, and/or lens aberration data, and/or the like, corresponding to attributes of the object(s) 145 within the image(s) 135 and/or the image(s) 135. In some cases, the orientation data may include information regarding orientation (or rotation) of an object 145 within an image 135 with respect to one or more of an x-axis, a y-axis, or a z-axis, which may be defined for or with respect to one of the environment 150, the object 145, the imaging system 155, or the image capture device 160. In some instances, the distance or zoom level data may include information regarding one of a level of zoom of the image capture device(s) 160, a first distance between the object 145 and the image capture device(s) 160, a second distance between the object 145 and a first reference point, or a third distance between the image capture device(s) 160 and a second reference point, at the time that the image 135 was captured by the image capture device(s) 160. In examples, the lighting condition data may include information regarding a lighting condition of the environment 150 in which the object 145 is located (e.g., due to light emitted from lighting sources, such as lighting source 150a, or the like) at the time that the image 135 was captured by the image capture device(s) 160. In some examples, the color description data may include information regarding at least one of color saturation, hue, or luminance of the image 135 as captured by the image capture device(s) 160. In some cases, the contrast data may include information regarding contrast or a difference between light and dark areas of an image. A low-contrast image may retain detail, but may lack dimension, while a normal contrast image may retain detail and dimension, and a high-contrast image may lose detail. In some instances, the lens aberration data may include information regarding (any) lens distortions of a lens used by the image capture device(s) 160 to capture the image 135. In some cases, the first reference point and/or the second reference point may include a holographic reference for light-based images/image capture devices (or similar analog for ultrasound, MRI, CT, etc.) for detecting lens distorting, and calibrated spatial angle references for camera, platform, and object(s) (where applicable).

In an example, the image processing system 105 and/or the computing system 110 may perform image processing on the image(s) 135 based on calibration data extracted from the calibration metadata 140 to produce normalized image(s) 180. However, not all images 135 have corresponding calibration metadata 140, and in such cases, an AI system(s) (e.g., AI system(s) 120a or 120b, or the like) may be used to compensate for the lack of calibration metadata. In such examples, the image processing system 105 and/or the computing system 110 may perform AI-assisted image processing on the image(s) 135 based on output from one of the AI system(s) 120a or the AI system(s) 120b to produce AI-assisted normalized image(s) 180. In examples, the one of the AI system(s) 120a or the AI system(s) 120b may use a corresponding one of the AI model(s) 125a or the AI model(s) 125b that is (are) trained on a plurality of training images to determine and to output one or more amounts by which the object(s) 145 within the image(s) 135 and/or the image(s) 135 should be changed to match a corresponding attribute of a reference object within a normalized reference image and/or of the normalized reference image. In some examples, the normalized image(s) 180 or the AI-assisted normalized image(s) 180 may include one or more of an orientation normalized image, a size normalized image, a lighting normalized image, a color normalized image, a contrast normalized image, or a distortion corrected image, and/or the like, based on corresponding one or more of the orientation data, the distance or zoom level data, the lighting condition data, the color description data, the contrast data, and/or the lens aberration data, and/or the like.

In some cases, the image processing system 105 and/or the computing system 110 may send the normalized image(s) 180 and/or the AI-assisted normalized image(s) 180 to a post processing system 185, via network(s) 175b. In some examples, the post processing system 185 may include an image processor(s) 190, a data store 170b, and the AI system(s) 120c. In some examples, the AI system(s) 120c may train and use AI model(s) 125c to identify and to highlight characteristics of objects in images, and may output a highlighted image(s) that highlights characteristics of the object(s) 145 in the normalized image(s) 180 or the AI-assisted normalized image(s) 180. In some instances, the characteristics of the object(s) 145 in the normalized image(s) 180 or the AI-assisted normalized image(s) 180 may include one of: (1) one or more first characteristics indicative of one of a particular disease, a medical condition, or a bodily injury (e.g., in a human, an animal, or a plant, or the like); (2) one or more second characteristics indicative of one or more telecommunications components being one of correctly connected, incorrectly connected, correctly installed, incorrectly installed, or experiencing one or more technical issues; (3) one or more third characteristics indicative of one or more semiconductor components being one of correctly connected, incorrectly connected, correctly positioned, incorrectly positioned, correctly aligned, misaligned, correctly mounted according to set standards, or incorrectly mounted according to the set standards; (4) one or more fourth characteristics indicative of one of collision damage to a vehicle, stress damage to at least a portion of the vehicle, or a manufacturing flaw in a component of the vehicle; or (5) one or more fifth characteristics indicative of one of conformance with manufacturing specifications for a manufactured component, nonconformance with the manufacturing specifications for the manufactured component, damage to the manufactured component during manufacturing processes, deformation of the manufactured component during manufacturing processes, or damage to the manufactured component during shipping of the manufactured component; and/or the like.

In some cases, the post processing system 185 and the AI system(s) 120b may be located within network(s) 175b. The post processing system 185 may send the output (in some cases, including the highlighted image(s) to one or more of devices 195a-195n, in some cases, via network(s) 175a and 175b and/or image processing system 105. In examples, the interface system(s) 130 of image processing system 105 may provide an interface (e.g., an application programming interface (“API”), etc.) to each of one or more of external AI systems (e.g., AI system(s) 120b, or the like), the post processing system 185, the imaging system 155, the image data store(s) 170a, or one or more of the devices 195a-195n, and/or the like, via the network(s) 175a or 175b. In some instances, the device(s) 195a-195n may each include, but is not limited to, one of a computing console, a desktop computer, a laptop computer, a tablet computer, a smart phone, or a mobile phone, and/or the like.

According to some embodiments, unless otherwise indicated, networks 175a and 175b may each include, without limitation, one of a local area network (“LAN”), including, without limitation, a fiber network, an Ethernet network, a Token-Ringä network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the networks 175a and 175b may include an access network of the service provider (e.g., an Internet service provider (“ISP”)). In another embodiment, the networks 175a and 175b may include a core network of the service provider and/or the Internet.

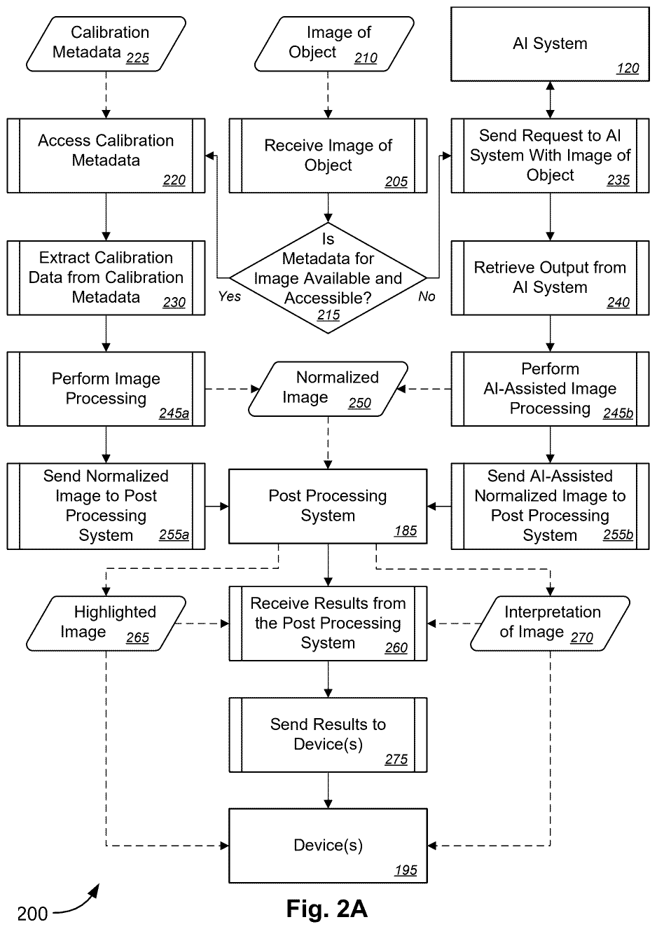

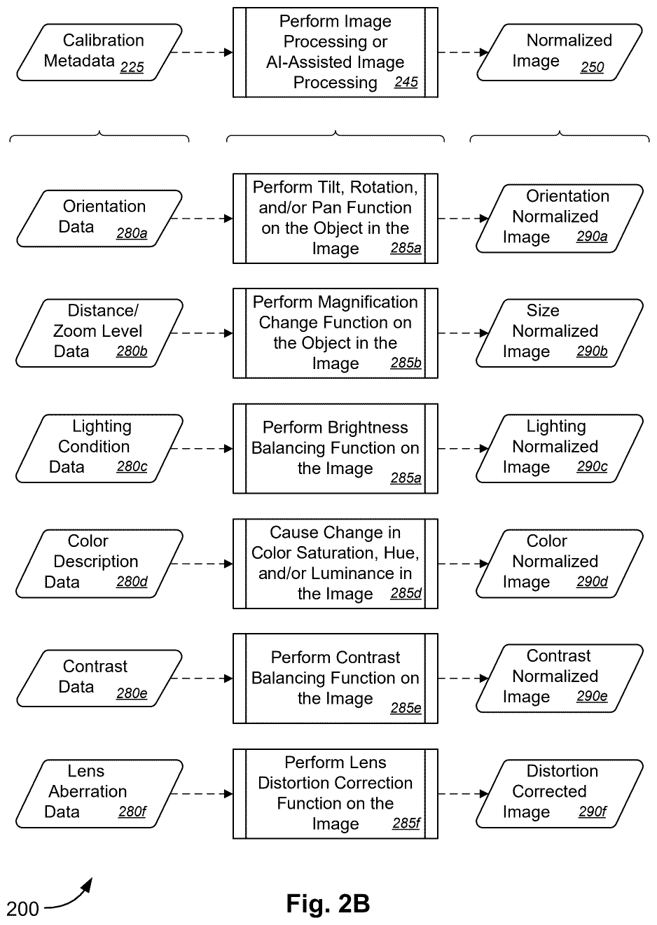

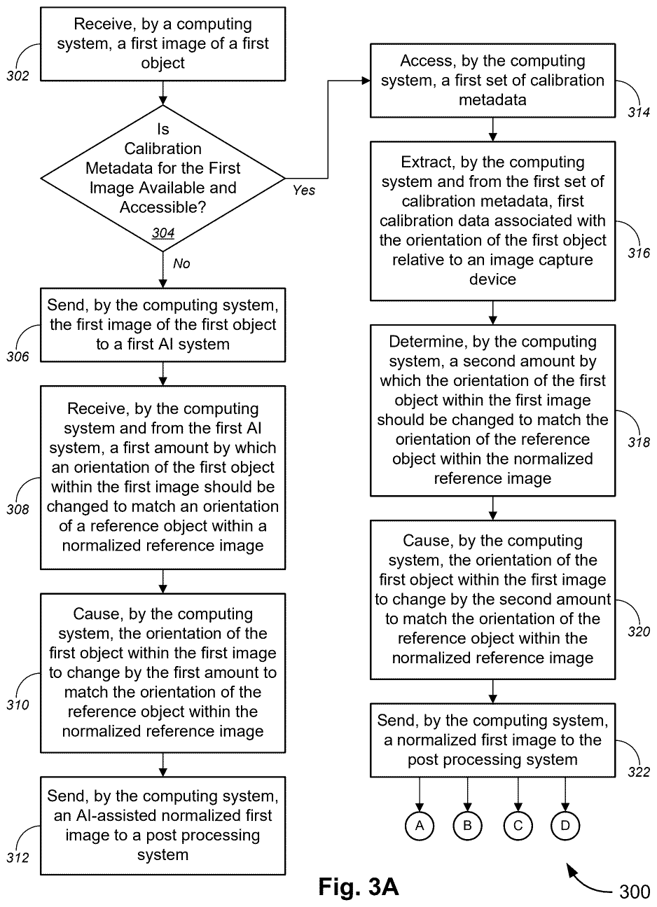

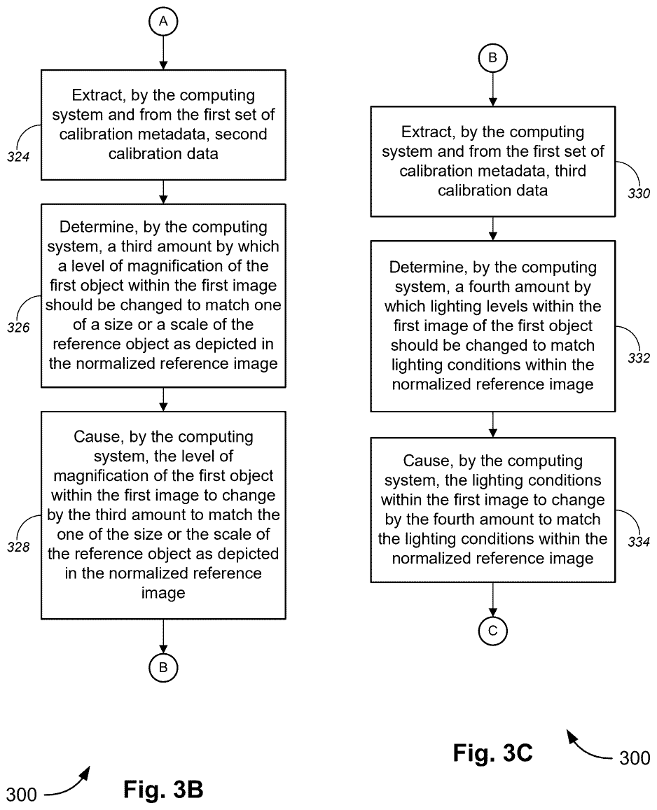

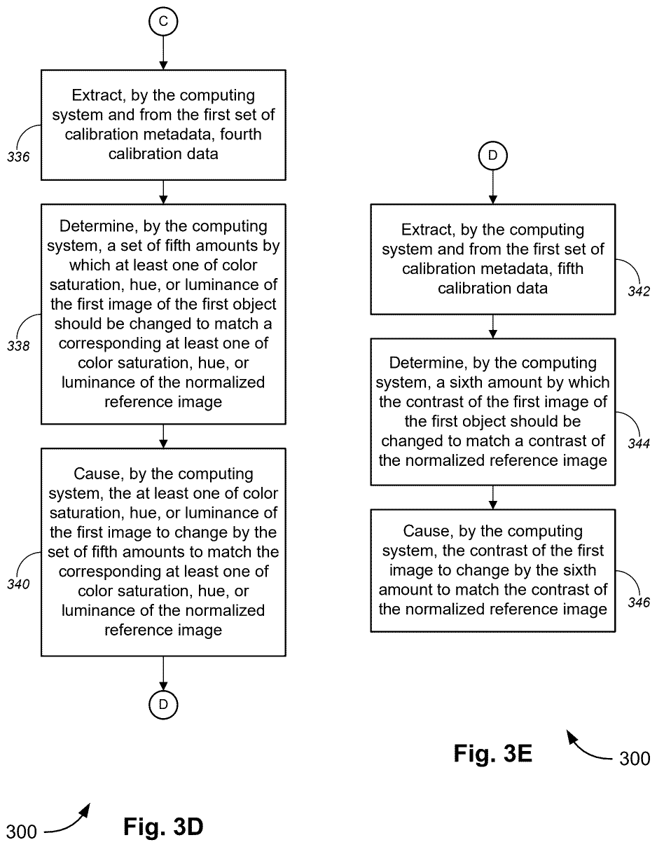

In operation, image processing system 105, computing system 110, and/or AI system(s) 120 may perform methods for implementing image normalization, as described in detail with respect to FIGS. 2-5. For example, example sequence flow 200 as described below with respect to FIGS. 2A and 2B, and methods 300, 400, and 500 as described below with respect to FIG. 3A-3E, 4A-4E, and 5, respectively, may be applied with respect to the operations of system 100 of FIG. 1.

FIGS. 2A and 2B (collectively, “FIG. 2”) depict an example sequence flow 200 for implementing image normalization, in accordance with various embodiments. Referring to FIGS. 2A and 2B, the operations 205, 215, 220, 230-245, 255a-260, 275, and 285a-285f may be performed by an image processing system (e.g., image processing system 105 of FIG. 1, or the like) and/or components thereof, including a computing system (e.g., computing system 110 of FIG. 1, or the like). In some embodiments, image 210 of object, calibration metadata 225, AI system 120, normalized image 250, post processing system 185, and device(s) 195 of FIGS. 2A and 2B may be similar, if not identical, to the image(s) 135, calibration metadata 140, AI systems 120a-120c, normalized image(s) 180, post processing system 185, and devices 195a-195n, respectively, of system 100 of FIG. 1, and the description of these components of system 100 of FIG. 1 are similarly applicable to the corresponding components of FIGS. 2A and 2B.

Referring to the example sequence flow 200 of FIG. 2A, at operation 205, an image processing system and/or a computing system may receive an image 210 of object (e.g., image(s) 135 of object(s) 145 of FIG. 1, or the like). At operation 215, the image processing system and/or the computing system may determine whether calibration metadata for the image 210 of object is available and accessible. If so, the example sequence flow 200 may continue onto the process at operation 220. If not, the example sequence flow 200 may continue onto the process at operation 235. At operation 220, the image processing system and/or the computing system may access calibration metadata 225. At operation 230, the image processing system and/or the computing system may extract calibration data from the calibration metadata 225. On the other hand, at operation 235, the image processing system and/or the computing system may send a request to AI system 120 with the image 210 of object. At operation 240, the image processing system and/or the computing system may retrieve an output from the AI system 120.

At operation 245, the image processing system and/or the computing system either may perform image processing (at operation 245a, after determining that the calibration metadata 225 is available and accessible) or may perform AI-assisted image processing (at operation 245b, after determining that the calibration metadata 225 is either not available or not accessible), to produce a corresponding one of normalized image or AI-assisted normalized image 250. At operation 255, the image processing system and/or the computing system may send the normalized image 250 (at operation 255a, after determining that the calibration metadata 225 is available and accessible) or may send the AI-assisted normalized image 250 (at operation 255b, after determining that the calibration metadata 225 is either not available or not accessible) to a post processing system 185.

At operation 260, the image processing system and/or the computing system may receive results, including a highlighted image 265 and/or an interpretation of image 270, from the post processing system. In some examples, the object in the image 210 may include one of at least a portion of a body of a human, at least a portion of a body of an animal, at least a portion of a plant, at least a portion of a telecommunications component, at least a portion of a semiconductor device, at least a portion of a vehicle, or at least a portion of a manufactured component, or the like. In examples, the highlighted image 265 may include an image that highlights characteristics of the first object in one of the normalized image 250 or the AI-assisted normalized image 250. In some instances, the characteristics of objects in images include one of: (1) one or more first characteristics indicative of one of a particular disease, a medical condition, or a bodily injury (e.g., in a human, an animal, or a plant, or the like); (2) one or more second characteristics indicative of one or more telecommunications components being one of correctly connected, incorrectly connected, correctly installed, incorrectly installed, or experiencing one or more technical issues; (3) one or more third characteristics indicative of one or more semiconductor components being one of correctly connected, incorrectly connected, correctly positioned, incorrectly positioned, correctly aligned, misaligned, correctly mounted according to set standards, or incorrectly mounted according to the set standards; (4) one or more fourth characteristics indicative of one of collision damage to a vehicle, stress damage to at least a portion of the vehicle, or a manufacturing flaw in a component of the vehicle; or (5) one or more fifth characteristics indicative of one of conformance with manufacturing specifications for a manufactured component, nonconformance with the manufacturing specifications for the manufactured component, damage to the manufactured component during manufacturing processes, deformation of the manufactured component during manufacturing processes, or damage to the manufactured component during shipping of the manufactured component; and/or the like. At operation 275, the image processing system and/or the computing system may send the results (e.g., the highlighted image 265 and/or the interpretation of image 270, or the like) to device(s) 295.

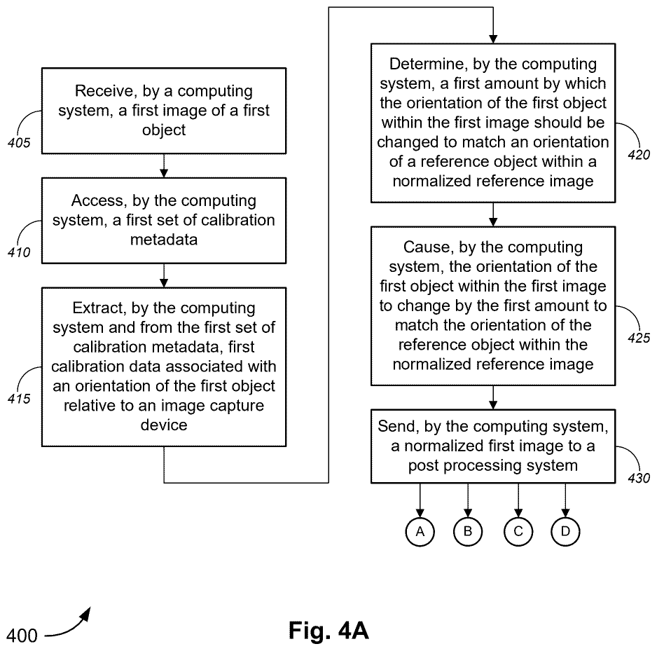

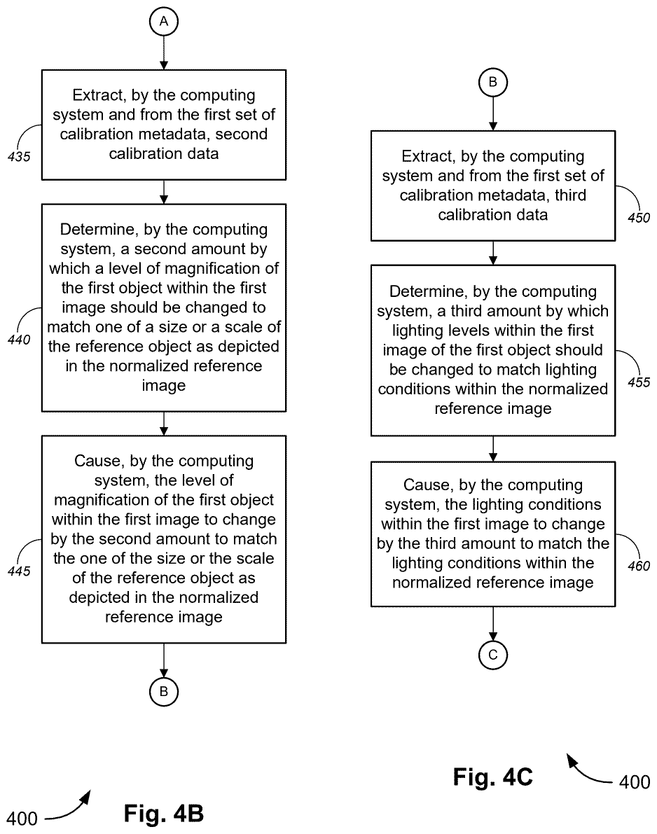

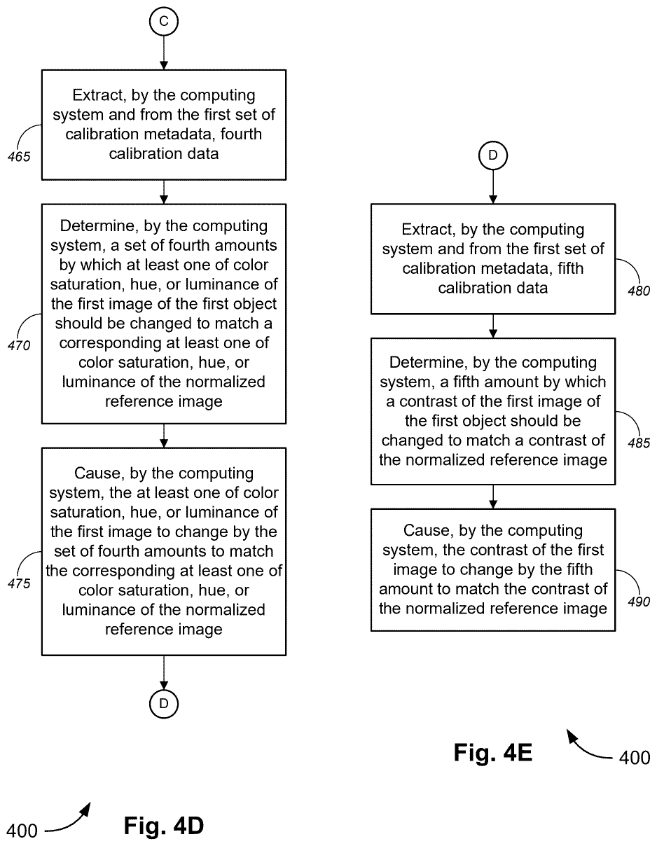

With reference to FIG. 2B, calibration metadata 225 may be used as a basis for performing image processing or AI-assisted image processing (at operation 245) to produce normalized image 250 or AI-assisted normalized image 250. In examples, calibration metadata 225 may include one or more of orientation data 280a, distance or zoom level data 280b, lighting condition data 280c, color description data 280d, contrast data 280e, and/or lens aberration data 280f, and/or the like. In an example, orientation data 280a may be used as a basis for performing at least one of a tilt function, a rotation function, or a pan function on the object in the image 210 (at operation 285a) to produce an orientation normalized image 290a. Alternatively or additionally, distance or zoom level data 280b may be used as a basis for performing a magnification change function on the object in the image 210 (at operation 285b) to produce a size normalized image 290b. Alternatively or additionally, lighting condition data 280c may be used as a basis for performing a brightness balancing function on the image 210 (at operation 285c) to produce a lighting normalized image 290c. Alternatively or additionally, color description data 280d may be used as a basis for causing a change in at least one of color saturation, hue, and/or luminance in the image 210 (at operation 285d) to produce a color normalized image 290d. Alternatively or additionally, contrast data 280e may be used as a basis for performing a contrast balancing function on the image 210 (at operation 285e) to produce a contrast normalized image 290e. Alternatively or additionally, lens aberration data 280f may be used as a basis for performing a lens distortion correction function on the image 210 (at operation 285f) to produce a distortion corrected image 290f. That is, operations 285a-285f may each correspond to operation 245 being performed based on a corresponding one of the orientation data 280a, the distance or zoom level data 280b, the lighting condition data 280c, the color description data 280d, the contrast data 280e, or the lens aberration data 280f, to produce a corresponding one of the orientation normalized image 290a, the size normalized image 290b, the lighting normalized image 290c, the color normalized image 290d, the contrast normalized image 290e, or the distortion corrected image 290f. These operations are described in detail below with respect to methods 300 and 400 in FIGS. 3B-3E and 4B-4E, respectively.

FIGS. 3A-3E (collectively, “FIG. 3”) depict flow diagrams illustrating an example method 300 for implementing image normalization, in accordance with various embodiments. With reference to FIGS. 3A-3E, the operations of example method 300 may be performed by an image processing system (e.g., image processing system 105 of FIG. 1, or the like), a computing system (e.g., computing system 110 of FIG. 1, or the like), and/or an AI system (e.g., AI system(s) 120 of FIGS. 1 and 2, or the like). Method 300 of FIG. 3A may continue onto one or more of FIG. 3B following the circular marker denoted, “A,” FIG. 3C following the circular marker denoted, “B,” FIG. 3D following the circular marker denoted, “C,” and/or FIG. 3E following the circular marker denoted, “D.” Method 300 of FIG. 3B may continue onto FIG. 3C following the circular marker denoted, “B.” Method 300 of FIG. 3C may continue onto FIG. 3D following the circular marker denoted, “C.” Method 300 of FIG. 3D may continue onto FIG. 3E following the circular marker denoted, “D.”

In the example method 300 of FIG. 3, at operation 302, a computing system may receive a first image of a first object (e.g., image(s) 135 of object(s) 145 of FIG. 1 or image 210 of object of FIG. 2A, or the like). At operation 304, the computing system may determine whether the first image of the first object has an associated set of calibration metadata that is accessible (and available) by the computing system. When it is determined either that there is no calibration metadata that is associated with the first image of the first object or that the first set of calibration metadata that is associated with the first image of the first object is not accessible, method 300 may continue onto the process at 306. On the other hand, when it is determined that a first set of calibration metadata that is associated with the first image of the first object is accessible, method 300 may continue onto the process at 314.

At operation 306, the computing system may send the first image of the first object to a first AI system (e.g., AI system(s) 120a-120c or 120 of FIG. 1 or 2A, or the like). At operation 308, the computing system may receive, from the first AI system, a first amount by which an orientation of the first object within the first image should be changed to match an orientation of a reference object within a normalized reference image. The computing system may perform AI-assisted image processing on the first image to produce an AI-assisted normalized first image, the AI-assisted image processing including causing the orientation of the first object within the first image to change by the first amount to match the orientation of the reference object within the normalized reference image (at operation 310). At operation 312, the computing system may send the AI-assisted normalized first image to a post processing system (e.g., post processing system 185 of FIG. 1 or 2A, or the like).

At operation 314, the computing system may access the first set of calibration metadata (e.g., calibration metadata 140 or 225 of FIG. 1 or 2A-2B, or the like). At operation 316, the computing system may extract, from the first set of calibration metadata, first calibration data (e.g., orientation data 280a of FIG. 2B, or the like) associated with an orientation of the first object relative to an image capture device (e.g., image capture device(s) 160 of FIG. 1, or the like) at a time that the first image was captured by the image capture device. In examples, the first set of calibration metadata is one of: (a) embedded within the first image, where accessing the first set of calibration metadata includes extracting the first set of calibration metadata from the first image; or (b) generated by a calibration system based on sensor data that are collected, by calibration sensors (e.g., calibration sensor(s) 165 of FIG. 1, or the like) mounted on the image capture device, at the time that the first image was captured by the image capture device, where accessing the first set of calibration metadata includes retrieving the first set of calibration metadata from the calibration system. In some examples, the first image of the first object is received from one of the image capture device, a medical scanning device, a quality control scanning system, a diagnostic scanning system, or an image datastore, or the like. In some cases, the image capture device may include one of a light-based image capture device (e.g., an optical camera or a camera operating in the visual spectrum, a camera operating in the IR spectrum, or a camera operating in the UV spectrum, etc.), a laser-based image capture device (e.g., a lidar imaging device, or the like), an X-ray-based imaging device (e.g., an X-ray radiography system, a CT scanning system, a fluoroscopy-based imaging system, a mammography system, an angiography system, or the like), an ionizing radiation-based imaging device (e.g., imaging systems using alpha particles, beta particles, positrons, gamma rays, or X-rays, etc.), a magnetic field-based imaging device (e.g., a MRI system, or the like), a sound-based imaging device (e.g., an ultrasound imaging device, or the like), a radiation emission detection-based imaging device (e.g., PET system, or the like), or the like.

At operation 318, the computing system may determine a second amount by which the orientation of the first object within the first image should be changed to match the orientation of the reference object within the normalized reference image, based on the first calibration data. The computing system may perform image processing on the first image to produce a normalized first image (e.g., normalized first image(s) 180 or 250 of FIG. 1 or 2A-2B, or the like), the image processing including causing the orientation of the first object within the first image to change by the second amount to match the orientation of the reference object within the normalized reference image (at operation 320). At operation 322, the computing system may send the normalized first image to the post processing system.

In example, causing the orientation of the first object within the first image to change by the first amount (at operation 320) may include causing at least one of a tilt function, a rotation function, or a pan function to be applied to the first object within the first image such that the first object is rotated within the first image with respect to a corresponding at least one of an x-axis, a y-axis, or a z-axis. In an example, the computing system may receive one or more second images of the first object, each second image of the first object depicting a different orientation of the first object relative to the image capture device at the time that that second image was captured by the image capture device. In such cases, causing the at least one of the tilt function, the rotation function, or the pan function to be applied to the first object within the first image may be based at least in part on portions of the first object being revealed from the different orientations of the first object as depicted by the one or more second images of the first object. In another example, the image capture device captures a three-dimensional (“3D”) representation of the first object, while the first image of the first object depicts a two-dimensional (“2D”) view of the 3D representation of the first object. In such cases, causing the at least one of the tilt function, the rotation function, or the pan function to be applied to the first object within the first image may include causing the at least one of the tilt function, the rotation function, or the pan function to be applied to the 3D representation of the first object, where the normalized first image is a 2D view of the 3D representation after the at least one of the tilt function, the rotation function, or the pan function has been applied to the 3D representation of the first object.

In some examples, the first object may include one of at least a portion of a body of a human, at least a portion of a body of an animal, at least a portion of a plant, at least a portion of a telecommunications component, at least a portion of a semiconductor device, at least a portion of a vehicle, or at least a portion of a manufactured component, or the like. In some cases, the post processing system may include a second AI system that outputs a third image that highlights characteristics of the first object in one of the normalized first image or the AI-assisted normalized first image. In some instances, the characteristics of objects in images include one of: (1) one or more first characteristics indicative of one of a particular disease, a medical condition, or a bodily injury; (2) one or more second characteristics indicative of one or more telecommunications components being one of correctly connected, incorrectly connected, correctly installed, incorrectly installed, or experiencing one or more technical issues; (3) one or more third characteristics indicative of one or more semiconductor components being one of correctly connected, incorrectly connected, correctly positioned, incorrectly positioned, correctly aligned, misaligned, correctly mounted according to set standards, or incorrectly mounted according to the set standards; (4) one or more fourth characteristics indicative of one of collision damage to a vehicle, stress damage to at least a portion of the vehicle, or a manufacturing flaw in a component of the vehicle; or (5) one or more fifth characteristics indicative of one of conformance with manufacturing specifications for a manufactured component, nonconformance with the manufacturing specifications for the manufactured component, damage to the manufactured component during manufacturing processes, deformation of the manufactured component during manufacturing processes, or damage to the manufactured component during shipping of the manufactured component; and/or the like.

In examples, method 300 may continue onto one or more of the process at operation 324 in FIG. 3B following the circular marker denoted, “A,” the process at operation 330 in FIG. 3C following the circular marker denoted, “B,” the process at operation 336 in FIG. 3D following the circular marker denoted, “C,” and/or the process at operation 342 in FIG. 3E following the circular marker denoted, “D.”

At operation 324 in FIG. 3B (following the circular marker denoted, “A,” in FIG. 3A), method 300 may include the computing system extracting, from the first set of calibration metadata, second calibration data (e.g., distance or zoom level data 280b of FIG. 2B, or the like) that is associated with one of a level of zoom, a first distance between the first object and the image capture device, a second distance between the first object and a first reference point, or a third distance between the image capture device and a second reference point at the time that the first image was captured by the image capture device, or the like. At operation 326, the computing system may determine a third amount by which a level of magnification of the first object within the first image should be changed to match one of a size or a scale of the reference object as depicted in the normalized reference image, based on the second calibration data. In some examples, the image processing on the first image may further include causing the level of magnification of the first object within the first image to change by the third amount to match the one of the size or the scale of the reference object as depicted in the normalized reference image (at operation 328). In examples, method 300 may continue onto the process at operation 330 in FIG. 3C following the circular marker denoted, “B.”

At operation 330 in FIG. 3C (following the circular marker denoted, “B,” in FIG. 3A or 3B), and in the case that the image capture device is a light-based image capture device, method 300 may include the computing system extracting, from the first set of calibration metadata, third calibration data (e.g., lighting condition data 280c of FIG. 2B, or the like) that is associated with lighting conditions (as caused, e.g., by lighting source 150a of FIG. 1, or the like) of an environment (e.g., environment 150 of FIG. 1, or the like. in which the first object is located at the time that the first image was captured by the image capture device. At operation 332, the computing system may determine a fourth amount by which lighting levels within the first image of the first object should be changed to match lighting conditions within the normalized reference image, based on the third calibration data. In examples, the image processing on the first image may further include causing the lighting conditions within the first image to change by the fourth amount to match the lighting conditions within the normalized reference image (at operation 334). In some examples, causing the lighting conditions within the first image to change by the fourth amount to match the lighting conditions within the normalized reference image (at operation 334) may include causing portions of the first image having brightness levels above a threshold brightness value to become muted while causing portions of the first image having brightness levels below the threshold brightness value to become brighter such that a consistent brightness is achieved over an entirety of the first image. In examples, method 300 may continue onto the process at operation 336 in FIG. 3D following the circular marker denoted, “C.”

At operation 336 in FIG. 3D (following the circular marker denoted, “C,” in FIG. 3A or 3C), and in the case that the image capture device is a light-based image capture device, method 300 may include the computing system extracting, from the first set of calibration metadata, fourth calibration data (e.g., color description data 280d of FIG. 2B, or the like) that is associated with at least one of color saturation, hue, or luminance of the first image as captured by the image capture device. At operation 338, the computing system may determine a set of fifth amounts by which the at least one of color saturation, hue, or luminance of the first image of the first object should be changed to match a corresponding at least one of color saturation, hue, or luminance of the normalized reference image, based on the fourth calibration data. In some examples, the image processing on the first image may further include causing the at least one of color saturation, hue, or luminance of the first image to change by the set of fifth amounts to match the corresponding at least one of color saturation, hue, or luminance of the normalized reference image (at operation 340). In examples, method 300 may continue onto the process at operation 342 in FIG. 3E following the circular marker denoted, “D.”

At operation 342 in FIG. 3E (following the circular marker denoted, “D,” in FIG. 3A or 3D), and in the case that the image capture device is a light-based image capture device, method 300 may include the computing system extracting, from the first set of calibration metadata, fifth calibration data (e.g., contrast data 280e of FIG. 2B, or the like) that is associated with a contrast of the first image as captured by the image capture device. At operation 344, the computing system may determine a sixth amount by which the contrast of the first image of the first object should be changed to match a contrast of the normalized reference image, based on the fifth calibration data. In some examples, the image processing on the first image may further include causing the contrast of the first image to change by the sixth amount to match the contrast of the normalized reference image (at operation 340).

In some examples, method 300 may further include the computing system sending the first image of the first object to a third AI system, and receiving, from the third AI system, a distortion-corrected first image that corrects for image effects in the first image that are caused by lens distortions of a lens used by the image capture device to capture the first image.

FIGS. 4A-4E (collectively, “FIG. 4”) depict flow diagrams illustrating another example method 400 for implementing image normalization, in accordance with various embodiments. Referring to FIGS. 4A-4E, the operations of example method 400 may be performed by an image processing system (e.g., image processing system 105 of FIG. 1, or the like), a computing system (e.g., computing system 110 of FIG. 1, or the like), and/or an AI system (e.g., AI system(s) 120 of FIGS. 1 and 2, or the like). Method 400 of FIG. 4A may continue onto one or more of FIG. 4B following the circular marker denoted, “A,” FIG. 4C following the circular marker denoted, “B,” FIG. 4D following the circular marker denoted, “C,” and/or FIG. 4E following the circular marker denoted, “D.” Method 400 of FIG. 4B may continue onto FIG. 4C following the circular marker denoted, “B.” Method 400 of FIG. 4C may continue onto FIG. 4D following the circular marker denoted, “C.” Method 400 of FIG. 4D may continue onto FIG. 4E following the circular marker denoted, “D.”

In the example method 400 of FIG. 4, at operation 405, a computing system may receive a first image of a first object (e.g., image(s) 135 of object(s) 145 of FIG. 1 or image 210 of object of FIG. 2A, or the like). At operation 410, the computing system may access a first set of calibration metadata (e.g., calibration metadata 140 or 225 of FIG. 1 or 2A-2B, or the like) that is associated with the first image of the first object. At operation 415, the computing system may extract, from the first set of calibration metadata, first calibration data (e.g., orientation data 280a of FIG. 2B, or the like) associated with an orientation of the first object relative to an image capture device (e.g., image capture device(s) 160 of FIG. 1, or the like) at a time that the first image was captured by the image capture device. In examples, the first set of calibration metadata is one of: (a) embedded within the first image, where accessing the first set of calibration metadata includes extracting the first set of calibration metadata from the first image; or (b) generated by a calibration system based on sensor data that are collected, by calibration sensors (e.g., calibration sensor(s) 165 of FIG. 1, or the like) mounted on the image capture device, at the time that the first image was captured by the image capture device, where accessing the first set of calibration metadata includes retrieving the first set of calibration metadata from the calibration system. In some examples, the first image of the first object is received from one of the image capture device, a medical scanning device, a quality control scanning system, a diagnostic scanning system, or an image datastore, or the like. In some cases, the image capture device may include one of a light-based image capture device (e.g., an optical camera or a camera operating in the visual spectrum, a camera operating in the IR spectrum, or a camera operating in the UV spectrum, etc.), a laser-based image capture device (e.g., a lidar imaging device, or the like), an X-ray-based imaging device (e.g., an X-ray radiography system, a CT scanning system, a fluoroscopy-based imaging system, a mammography system, an angiography system, or the like), an ionizing radiation-based imaging device (e.g., imaging systems using alpha particles, beta particles, positrons, gamma rays, or X-rays, etc.), a magnetic field-based imaging device (e.g., a MRI system, or the like), a sound-based imaging device (e.g., an ultrasound imaging device, or the like), a radiation emission detection-based imaging device (e.g., PET system, or the like), or the like.

At operation 420, the computing system may determine a first amount by which the orientation of the first object within the first image should be changed to match an orientation of a reference object within a normalized reference image, based on the first calibration data. The computing system may perform image processing on the first image to produce a normalized first image (e.g., normalized first image(s) 180 or 250 of FIG. 1 or 2A-2B, or the like), the image processing including causing the orientation of the first object within the first image to change by the first amount to match the orientation of the reference object within the normalized reference image (at operation 425). At operation 430, the computing system may send the normalized first image to a post processing system (e.g., post processing system 185 of FIG. 1 or 2A, or the like).

In example, causing the orientation of the first object within the first image to change by the first amount (at operation 425) may include causing at least one of a tilt function, a rotation function, or a pan function to be applied to the first object within the first image such that the first object is rotated within the first image with respect to a corresponding at least one of an x-axis, a y-axis, or a z-axis. In an example, the computing system may receive one or more second images of the first object, each second image of the first object depicting a different orientation of the first object relative to the image capture device at the time that that second image was captured by the image capture device. In such cases, causing the at least one of the tilt function, the rotation function, or the pan function to be applied to the first object within the first image may be based at least in part on portions of the first object being revealed from the different orientations of the first object as depicted by the one or more second images of the first object. In another example, the image capture device captures a 3D representation of the first object, while the first image of the first object depicts a 2D view of the 3D representation of the first object, In such cases, causing the at least one of the tilt function, the rotation function, or the pan function to be applied to the first object within the first image may include causing the at least one of the tilt function, the rotation function, or the pan function to be applied to the 3D representation of the first object, where the normalized first image is a 2D view of the 3D representation after the at least one of the tilt function, the rotation function, or the pan function has been applied to the 3D representation of the first object.

In some examples, the first object may include one of at least a portion of a body of a human, at least a portion of a body of an animal, at least a portion of a plant, at least a portion of a telecommunications component, at least a portion of a semiconductor device, at least a portion of a vehicle, or at least a portion of a manufactured component, or the like. In some cases, the post processing system may include a first AI system (e.g., AI system(s) 120a-120c or 120 of FIG. 1 or 2A, or the like) that outputs a third image that highlights characteristics of the first object in one of the normalized first image. In some instances, the characteristics of objects in images may include one of: (1) one or more first characteristics indicative of one of a particular disease, a medical condition, or a bodily injury; (2) one or more second characteristics indicative of one or more telecommunications components being one of correctly connected, incorrectly connected, correctly installed, incorrectly installed, or experiencing one or more technical issues; (3) one or more third characteristics indicative of one or more semiconductor devices being one of correctly connected, incorrectly connected, correctly positioned, incorrectly positioned, correctly aligned, misaligned, correctly mounted according to set standards, or incorrectly mounted according to the set standards; (4) one or more fourth characteristics indicative of one of collision damage to a vehicle, stress damage to at least a portion of the vehicle, or a manufacturing flaw in a component of the vehicle; or (5) one or more fifth characteristics indicative of one of conformance with manufacturing specifications for a manufactured component, nonconformance with the manufacturing specifications for the manufactured component, damage to the manufactured component during manufacturing processes, deformation of the manufactured component during manufacturing processes, or damage to the manufactured component during shipping of the manufactured component; and/or the like.

In examples, method 400 may continue onto one or more of the process at operation 435 in FIG. 4B following the circular marker denoted, “A,” the process at operation 450 in FIG. 4C following the circular marker denoted, “B,” the process at operation 465 in FIG. 4D following the circular marker denoted, “C,” and/or the process at operation 480 in FIG. 4E following the circular marker denoted, “D.”

At operation 435 in FIG. 4B (following the circular marker denoted, “A,” in FIG. 4A), method 400 may include the computing system extracting, from the first set of calibration metadata, second calibration data (e.g., distance or zoom level data 280b of FIG. 2B, or the like) that is associated with one of a level of zoom, a first distance between the first object and the image capture device, a second distance between the first object and a first reference point, or a third distance between the image capture device and a second reference point at the time that the first image was captured by the image capture device, or the like. At operation 440, the computing system may determine a second amount by which a level of magnification of the first object within the first image should be changed to match one of a size or a scale of the reference object as depicted in the normalized reference image, based on the second calibration data. In some examples, the image processing on the first image may further include causing the level of magnification of the first object within the first image to change by the second amount to match the one of the size or the scale of the reference object as depicted in the normalized reference image (at operation 445). In examples, method 400 may continue onto the process at operation 450 in FIG. 4C following the circular marker denoted, “B.”

At operation 450 in FIG. 4C (following the circular marker denoted, “B,” in FIG. 4A or 4B), and in the case that the image capture device is a light-based image capture device, method 400 may include the computing system extracting, from the first set of calibration metadata, third calibration data (e.g., lighting condition data 280c of FIG. 2B, or the like) that is associated with lighting conditions (as caused, e.g., by lighting source 150a of FIG. 1, or the like) of an environment (e.g., environment 150 of FIG. 1, or the like) in which the first object is located at the time that the first image was captured by the image capture device. At operation 455, the computing system may determine a third amount by which lighting levels within the first image of the first object should be changed to match lighting conditions within the normalized reference image, based on the third calibration data. In examples, the image processing on the first image may further include causing the lighting conditions within the first image to change by the third amount to match the lighting conditions within the normalized reference image (at operation 460). In some examples, causing the lighting conditions within the first image to change by the third amount to match the lighting conditions within the normalized reference image (at operation 460) may include causing portions of the first image having brightness levels above a threshold brightness value to become muted while causing portions of the first image having brightness levels below the threshold brightness value to become brighter such that a consistent brightness is achieved over an entirety of the first image. In examples, method 400 may continue onto the process at operation 465 in FIG. 4D following the circular marker denoted, “C.”

At operation 465 in FIG. 4D (following the circular marker denoted, “C,” in FIG. 4A or 4C), and in the case that the image capture device is a light-based image capture device, method 400 may include the computing system extracting, from the first set of calibration metadata, fourth calibration data (e.g., color description data 280d of FIG. 2B, or the like) that is associated with at least one of color saturation, hue, or luminance of the first image as captured by the image capture device. At operation 470, the computing system may determine a set of fourth amounts by which the at least one of color saturation, hue, or luminance of the first image of the first object should be changed to match a corresponding at least one of color saturation, hue, or luminance of the normalized reference image, based on the fourth calibration data. In some examples, the image processing on the first image may further include causing the at least one of color saturation, hue, or luminance of the first image to change by the set of fourth amounts to match the corresponding at least one of color saturation, hue, or luminance of the normalized reference image (at operation 475). In examples, method 400 may continue onto the process at operation 480 in FIG. 4E following the circular marker denoted, “D.”

At operation 480 in FIG. 4E (following the circular marker denoted, “D,” in FIG. 4A or 4D), and in the case that the image capture device is a light-based image capture device, method 400 may include the computing system extracting, from the first set of calibration metadata, fifth calibration data (e.g., contrast data 280e of FIG. 2B, or the like) that is associated with a contrast of the first image as captured by the image capture device. At operation 485, the computing system may determine a fifth amount by which the contrast of the first image of the first object should be changed to match a contrast of the normalized reference image, based on the fifth calibration data. In some examples, the image processing on the first image may further include causing the contrast of the first image to change by the fifth amount to match the contrast of the normalized reference image (at operation 490).

In some examples, method 400 may further include the computing system sending the first image of the first object to a second AI system, and receiving, from the second AI system, a distortion-corrected first image that corrects for image effects in the first image that are caused by lens distortions of a lens used by the image capture device to capture the first image.

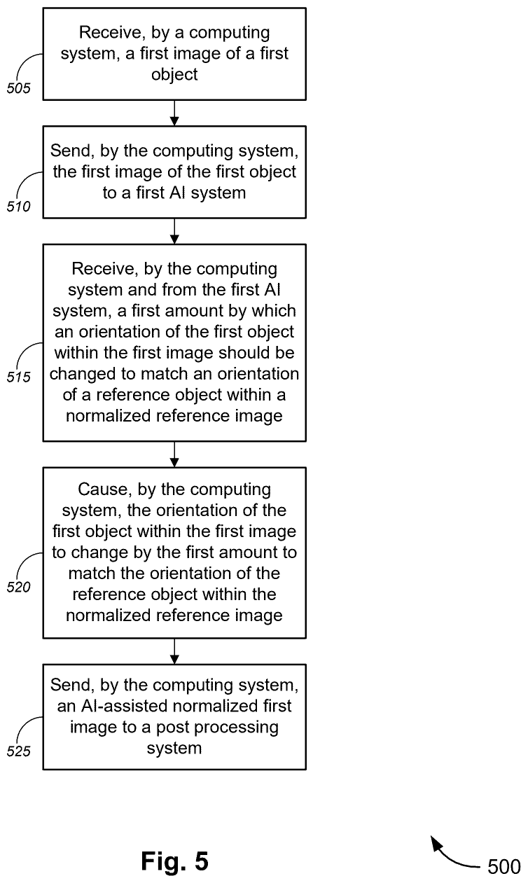

FIG. 5 depicts flow diagrams illustrating yet another method 500 for implementing image normalization, in accordance with various embodiments. With reference to FIG. 5, the operations of example method 500 may be performed by an image processing system (e.g., image processing system 105 of FIG. 1, or the like), a computing system (e.g., computing system 110 of FIG. 1, or the like), and/or an AI system (e.g., AI system(s) 120 of FIGS. 1 and 2, or the like).

In the example method 500 of FIG. 5, at operation 505, a computing system may receive a first image of a first object (e.g., image(s) 135 of object(s) 145 of FIG. 1 or image 210 of object of FIG. 2A, or the like). At operation 510, the computing system may send the first image of the first object to a first AI system (e.g., AI system(s) 120a-120c or 120 of FIG. 1 or 2A, or the like). At operation 515, the computing system may receive, from the first AI system, a first amount by which an orientation of the first object within the first image should be changed to match an orientation of a reference object within a normalized reference image. The computing system may perform AI-assisted image processing on the first image to produce an AI-assisted normalized first image, the AI-assisted image processing including causing the orientation of the first object within the first image to change by the first amount to match the orientation of the reference object within the normalized reference image (at operation 520). At operation 525, the computing system may send the AI-assisted normalized first image to a post processing system (e.g., post processing system 185 of FIG. 1 or 2A, or the like).

While the techniques and procedures in methods 300, 400, and 500 are depicted and/or described in a certain order for purposes of illustration, it should be appreciated that certain procedures may be reordered and/or omitted within the scope of various embodiments. Moreover, while the methods 300, 400, and 500 may be implemented by or with (and, in some cases, are described below with respect to) the systems, examples, or embodiments 100 and 200 of FIGS. 1 and 2A-2B, respectively (or components thereof), such methods may also be implemented using any suitable hardware (or software) implementation. Similarly, while each of the systems, examples, or embodiments 100 and 200 of FIGS. 1 and 2A-2B, respectively (or components thereof), can operate according to the methods 300, 400, and 500 (e.g., by executing instructions embodied on a computer readable medium), the systems, examples, or embodiments 100 and 200 of FIGS. 1 and 2A-2B can each also operate according to other modes of operation and/or perform other suitable procedures.

### Exemplary System and Hardware Implementation

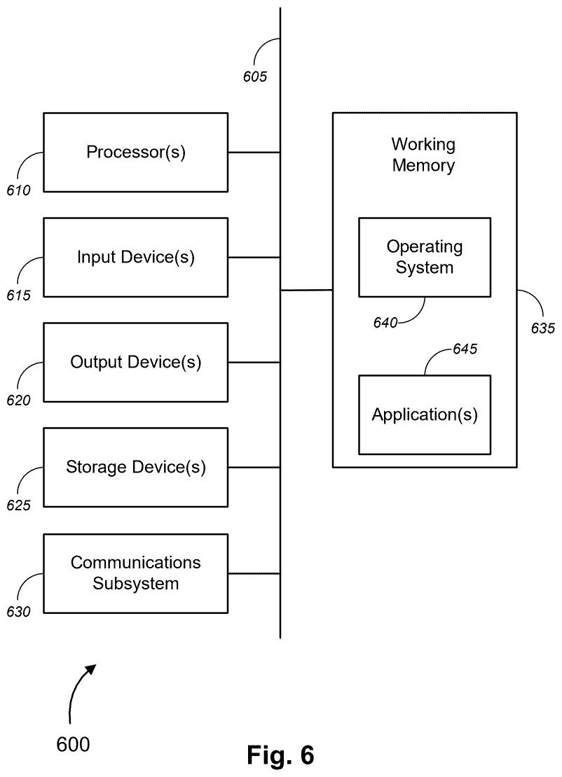

FIG. 6 is a block diagram illustrating an exemplary computer or system hardware architecture, in accordance with various embodiments. FIG. 6 provides a schematic illustration of one embodiment of a computer system 600 of the service provider system hardware that can perform the methods provided by various other embodiments, as described herein, and/or can perform the functions of computer or hardware system (i.e., image processing system 105, computing system 110, AI systems 120a-120c and 120, imaging system 155, post processing system 185, image processor(s) 190, and devices 195a-195n and 195, etc.), as described above. It should be noted that FIG. 6 is meant only to provide a generalized illustration of various components, of which one or more (or none) of each may be utilized as appropriate. FIG. 6, therefore, broadly illustrates how individual system elements may be implemented in a relatively separated or relatively more integrated manner.

The computer or hardware system 600—which might represent an embodiment of the computer or hardware system (i.e., image processing system 105, computing system 110, AI systems 120a-120c and 120, imaging system 155, post processing system 185, image processor(s) 190, and devices 195a-195n and 195, etc.), described above with respect to FIGS. 1-5—is shown including hardware elements that can be electrically coupled via a bus 605 (or may otherwise be in communication, as appropriate). The hardware elements may include one or more processors 610, including, without limitation, one or more general-purpose processors and/or one or more special-purpose processors (such as microprocessors, digital signal processing chips, graphics acceleration processors, and/or the like); one or more input devices 615, which can include, without limitation, a mouse, a keyboard, and/or the like; and one or more output devices 620, which can include, without limitation, a display device, a printer, and/or the like.

The computer or hardware system 600 may further include (and/or be in communication with) one or more storage devices 625, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 600 might also include a communications subsystem 630, which can include, without limitation, a modem, a network card (wireless or wired), an infra-red communication device, a wireless communication device and/or chipset (such as a Bluetooth™ device, an 802.11 device, a Wi-Fi device, a WiMAX device, a WWAN device, cellular communication facilities, etc.), and/or the like. The communications subsystem 630 may permit data to be exchanged with a network (such as the network described below, to name one example), with other computer or hardware systems, and/or with any other devices described herein. In many embodiments, the computer or hardware system 600 will further include a working memory 635, which can include a RAM or ROM device, as described above.

The computer or hardware system 600 also may include software elements, shown as being currently located within the working memory 635, including an operating system 640, device drivers, executable libraries, and/or other code, such as one or more application programs 645, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 625 described above. In some cases, the storage medium might be incorporated within a computer system, such as the system 600. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 600 and/or might take the form of source and/or installable code, which, upon compilation and/or installation on the computer or hardware system 600 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 600) to perform methods in accordance with various embodiments of the invention. According to a set of embodiments, some or all of the procedures of such methods are performed by the computer or hardware system 600 in response to processor 610 executing one or more sequences of one or more instructions (which might be incorporated into the operating system 640 and/or other code, such as an application program 645) contained in the working memory 635. Such instructions may be read into the working memory 635 from another computer readable medium, such as one or more of the storage device(s) 625. Merely by way of example, execution of the sequences of instructions contained in the working memory 635 might cause the processor(s) 610 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 600, various computer readable media might be involved in providing instructions/code to processor(s) 610 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 625. Volatile media includes, without limitation, dynamic memory, such as the working memory 635. In some alternative embodiments, a computer readable medium may take the form of transmission media, which includes, without limitation, coaxial cables, copper wire, and fiber optics, including the wires that include the bus 605, as well as the various components of the communication subsystem 630 (and/or the media by which the communications subsystem 630 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 600. These signals, which might be in the form of electromagnetic signals, acoustic signals, optical signals, and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims

What is claimed is:

1. A method, comprising:
receiving, by a computing system, a first image of a first object;
determining, by the computing system, whether the first image of the first object has an associated set of calibration metadata that is accessible by the computing system;
when it is determined either that there is no calibration metadata that is associated with the first image of the first object or that a first set of calibration metadata that is associated with the first image of the first object is not accessible,
sending, by the computing system, the first image of the first object to a first artificial intelligence (“AI”) system;
receiving, by the computing system and from the first AI system, a first amount by which an orientation of the first object within the first image should be changed to match an orientation of a reference object within a normalized reference image;
performing, by the computing system, AI-assisted image processing on the first image to produce an AI-assisted normalized first image, the AI-assisted image processing including causing the orientation of the first object within the first image to change by the first amount to match the orientation of the reference object within the normalized reference image; and
sending, by the computing system, the AI-assisted normalized first image to a post processing system
when it is determined that the first set of calibration metadata that is associated with the first image of the first object is accessible,
accessing, by the computing system, the first set of calibration metadata;
extracting, by the computing system and from the first set of calibration metadata, first calibration data associated with the orientation of the first object relative to an image capture device at a time that the first image was captured by the image capture device;
determining, by the computing system, a second amount by which the orientation of the first object within the first image should be changed to match the orientation of the reference object within the normalized reference image, based on the first calibration data;
performing, by the computing system, image processing on the first image to produce a normalized first image, the image processing including causing the orientation of the first object within the first image to change by the second amount to match the orientation of the reference object within the normalized reference image; and
sending, by the computing system, the normalized first image to the post processing system.

2. The method of claim 1, wherein the first set of calibration metadata is one of:
embedded within the first image, wherein accessing the first set of calibration metadata comprises extracting the first set of calibration metadata from the first image; or
generated by a calibration system based on sensor data that are collected, by calibration sensors mounted on the image capture device, at the time that the first image was captured by the image capture device, wherein accessing the first set of calibration metadata comprises retrieving the first set of calibration metadata from the calibration system.

3. The method of claim 1, wherein the first image of the first object is received from one of the image capture device, a medical scanning device, a quality control scanning system, a diagnostic scanning system, or an image datastore.

4. The method of claim 1, wherein the image capture device includes one of a light-based image capture device, a laser-based image capture device, an X-ray-based imaging device, an ionizing radiation-based imaging device, a magnetic field-based imaging device, a sound-based imaging device, a radiation emission detection-based imaging device.

5. The method of claim 1, wherein causing the orientation of the first object within the first image to change by the first amount comprises causing at least one of a tilt function, a rotation function, or a pan function to be applied to the first object within the first image such that the first object is rotated within the first image with respect to a corresponding at least one of an x-axis, a y-axis, or a z-axis.

6. The method of claim 5, further comprising:
receiving, by the computing system, one or more second images of the first object, each second image of the first object depicting a different orientation of the first object relative to the image capture device at the time that that second image was captured by the image capture device;
wherein causing the at least one of the tilt function, the rotation function, or the pan function to be applied to the first object within the first image is based at least in part on portions of the first object being revealed from the different orientations of the first object as depicted by the one or more second images of the first object.

7. The method of claim 5, wherein the image capture device captures a three-dimensional (“3D”) representation of the first object, wherein the first image of the first object depicts a two-dimensional (“2D”) view of the 3D representation of the first object, wherein causing the at least one of the tilt function, the rotation function, or the pan function to be applied to the first object within the first image comprises causing the at least one of the tilt function, the rotation function, or the pan function to be applied to the 3D representation of the first object, wherein the normalized first image is a 2D view of the 3D representation after the at least one of the tilt function, the rotation function, or the pan function has been applied to the 3D representation of the first object.

8. The method of claim 1, wherein the first set of calibration metadata further includes second calibration data associated with one of a level of zoom, a first distance between the first object and the image capture device, a second distance between the first object and a first reference point, or a third distance between the image capture device and a second reference point, at the time that the first image was captured by the image capture device, wherein the method further comprises:
extracting, by the computing system and from the first set of calibration metadata, the second calibration data; and
determining, by the computing system, a third amount by which a level of magnification of the first object within the first image should be changed to match one of a size or a scale of the reference object as depicted in the normalized reference image, based on the second calibration data;
wherein the image processing on the first image further includes causing the level of magnification of the first object within the first image to change by the third amount to match the one of the size or the scale of the reference object as depicted in the normalized reference image.

9. The method of claim 1, wherein the image capture device is a light-based image capture device, wherein the first set of calibration metadata further includes third calibration data associated with lighting conditions of an environment in which the first object is located at the time that the first image was captured by the image capture device, wherein the method further comprises:
extracting, by the computing system and from the first set of calibration metadata, the third calibration data; and
determining, by the computing system, a fourth amount by which lighting levels within the first image of the first object should be changed to match lighting conditions within the normalized reference image, based on the third calibration data;
wherein the image processing on the first image further includes causing the lighting conditions within the first image to change by the fourth amount to match the lighting conditions within the normalized reference image.

10. The method of claim 9, wherein causing the lighting conditions within the first image to change by the fourth amount to match the lighting conditions within the normalized reference image comprises causing portions of the first image having brightness levels above a threshold brightness value to become muted while causing portions of the first image having brightness levels below the threshold brightness value to become brighter such that a consistent brightness is achieved over an entirety of the first image.

11. The method of claim 1, wherein the image capture device is a light-based image capture device, wherein the first set of calibration metadata further includes fourth calibration data associated with at least one of color saturation, hue, luminance, or contrast of the first image as captured by the image capture device, wherein the method further comprises:
extracting, by the computing system and from the first set of calibration metadata, the fourth calibration data; and
determining, by the computing system, a set of fifth amounts by which the at least one of color saturation, hue, luminance, or contrast of the first image of the first object should be changed to match a corresponding at least one of color saturation, hue, luminance, or contrast of the normalized reference image, based on the fourth calibration data;
wherein the image processing on the first image further includes causing the at least one of color saturation, hue, luminance, or contrast of the first image to change by the set of fifth amounts to match the corresponding at least one of color saturation, hue, luminance, or contrast of the normalized reference image.

12. The method of claim 1, wherein the first object includes one of at least a portion of a body of a human, at least a portion of a body of an animal, at least a portion of a plant, at least a portion of a telecommunications component, at least a portion of a semiconductor device, at least a portion of a vehicle, or at least a portion of a manufactured component.

13. The method of claim 1, wherein the post processing system includes a second AI system that outputs a third image that highlights characteristics of the first object in one of the normalized first image or the AI-assisted normalized first image.

14. The method of claim 13, wherein the characteristics of objects in images include one of:
one or more first characteristics indicative of one of a particular disease, a medical condition, or a bodily injury;
one or more second characteristics indicative of one or more telecommunications components being one of correctly connected, incorrectly connected, correctly installed, incorrectly installed, or experiencing one or more technical issues;
one or more third characteristics indicative of one or more semiconductor components being one of correctly connected, incorrectly connected, correctly positioned, incorrectly positioned, correctly aligned, misaligned, correctly mounted according to set standards, or incorrectly mounted according to the set standards;
one or more fourth characteristics indicative of one of collision damage to a vehicle, stress damage to at least a portion of the vehicle, or a manufacturing flaw in a component of the vehicle; or
one or more fifth characteristics indicative of one of conformance with manufacturing specifications for a manufactured component, nonconformance with the manufacturing specifications for the manufactured component, damage to the manufactured component during manufacturing processes, deformation of the manufactured component during manufacturing processes, or damage to the manufactured component during shipping of the manufactured component.

15. The method of claim 1, further comprising:
sending, by the computing system, the first image of the first object to a third AI system; and
receiving, by the computing system and from the third AI system, a distortion-corrected first image that corrects for image effects in the first image that are caused by lens distortions of a lens used by the image capture device to capture the first image.

16. A system, comprising:
a processing system; and
memory coupled to the processing system, the memory comprising computer executable instructions that, when executed by the processing system, causes the system to perform operations comprising:
receiving a first image of a first object;
sending the first image of the first object to a first artificial intelligence (“AI”) system;
receiving, from the first AI system, a first amount by which an orientation of the first object within the first image should be changed to match an orientation of a reference object within a normalized reference image;
performing AI-assisted image processing on the first image to produce an AI-assisted normalized first image, the AI-assisted image processing including causing the orientation of the first object within the first image to change by the first amount to match the orientation of the reference object within the normalized reference image; and
sending the AI-assisted normalized first image to a post processing system.

17. A method, comprising:
receiving, by a computing system, a first image of a first object;
accessing, by the computing system, a first set of calibration metadata that is associated with the first image of the first object;
extracting, by the computing system and from the first set of calibration metadata, first calibration data associated with an orientation of the first object relative to an image capture device at a time that the first image was captured by the image capture device;
determining, by the computing system, a first amount by which the orientation of the first object within the first image should be changed to match an orientation of a reference object within a normalized reference image, based on the first calibration data;
performing, by the computing system, image processing on the first image to produce a normalized first image, the image processing including causing the orientation of the first object within the first image to change by the first amount to match the orientation of the reference object within the normalized reference image; and
sending, by the computing system, the normalized first image to a post processing system.

18. The method of claim 17, wherein causing the orientation of the first object within the first image to change by the first amount comprises causing at least one of a tilt function, a rotation function, or a pan function to be applied to the first object within the first image such that the first object is rotated within the first image with respect to a corresponding at least one of an x-axis, a y-axis, or a z-axis.

19. The method of claim 17, wherein the first set of calibration metadata further includes second calibration data associated with one of a level of zoom, a first distance between the first object and the image capture device, a second distance between the first object and a first reference point, or a third distance between the image capture device and a second reference point at the time that the first image was captured by the image capture device, wherein the method further comprises:
extracting, by the computing system and from the first set of calibration metadata, the second calibration data; and
determining, by the computing system, a second amount by which a level of magnification of the first object within the first image should be changed to match one of a size or a scale of the reference object as depicted in the normalized reference image, based on the second calibration data;
wherein the image processing on the first image further includes causing the level of magnification of the first object within the first image to change by the second amount to match the one of the size or the scale of the reference object as depicted in the normalized reference image.

20. The method of claim 17, wherein the image capture device is a light-based image capture device, wherein the first set of calibration metadata further includes third calibration data associated with lighting conditions of an environment in which the first object is located at the time that the first image was captured by the image capture device, wherein the method further comprises:
extracting, by the computing system and from the first set of calibration metadata, the third calibration data; and
determining, by the computing system, a third amount by which lighting levels within the first image of the first object should be changed to match lighting conditions within the normalized reference image, based on the third calibration data;
wherein the image processing on the first image further includes causing the lighting conditions within the first image to change by the third amount to match the lighting conditions within the normalized reference image.
